(19) United States
(12) Patent Application Publication
(10) Pub. No.: US 2025/0208434 A1
(43) Pub. Date: Jun. 26, 2025

(54) OPTICAL PRODUCTS, MASTERS FOR FABRICATING OPTICAL PRODUCTS, AND METHODS FOR MANUFACTURING MASTERS AND OPTICAL PRODUCTS

(71) Applicant: WAVEFRONT TECHNOLOGY, INC., Paramount, CA (US)

(72) Inventors: Christopher Chapman Rich, Rancho Palos Verdes, CA (US); Phillip Christopher Harvey, Long Beach, CA (US); Joel Mikael Petersen, Valley Village, CA (US)

(21) Appl. No.: 18/787,809

(22) Filed: Jul. 29, 2024

Related U.S. Application Data
(63) Continuation of application No. 17/071,872, filed on Oct. 15, 2020, now Pat. No. 12,078,821.
Application No. 17/071,872 is a continuation of application No. 14/921,933, filed on Oct. 23, 2015, now Pat. No. 10,859,851.
(60) Provisional application No. 62/068,540, filed on Oct. 24, 2014.

(51) Int. Cl. G02B 30/40; B42D 25/29; B42D 25/324; B42D 25/328; G02B 5/04; G03H 1/00

(52) U.S. Cl. CPC G02B 30/40; B42D 25/29; B42D 25/324; B42D 25/328; G02B 5/045; G03H 1/0011

(57) ABSTRACT

In certain embodiments, a master for fabricating an optical product is disclosed. For example, the optical product can be configured to be an anti-counterfeit feature such as a patch, a window, or a thread on a banknote. The optical product can be configured, when illuminated, to reproduce by reflected or refracted light, a 3D image of at least a part of a 3D object. The master can include a first surface and a second surface opposite the first surface. The second surface can include a plurality of portions. Each portion can correspond to a point on a surface of the 3D object. Each portion can include features corresponding to non-holographic elements on the optical product. A gradient in the features can correlate to an inclination of the surface of the 3D object at the corresponding point. An orientation of the features can correlate to an orientation of the surface of the 3D object at the corresponding point.

### INCORPORATION BY REFERENCE TO ANY PRIORITY APPLICATIONS

This application is a continuation of U.S. patent application Ser. No. 17/071,872, filed Oct. 15, 2020, which is a continuation of U.S. patent application Ser. No. 14/921,933 filed Oct. 23, 2015, which claims the benefit of priority of U.S. Provisional Application No. 62/068,540 filed on Oct. 24, 2014. The entirety of each application referenced in this paragraph is expressly incorporated herein by reference.

### TECHNICAL FIELD

The present application generally relates to optical products, masters (e.g., master and/or daughter shims) for fabricating an optical product, and methods for manufacturing the masters and optical products. In particular, the optical product can be configured, when illuminated, to reproduce by reflected (or refracted) light, a 3D image (e.g., an image that appears three-dimensional) of at least a part of a 3D object.

### DESCRIPTION OF THE RELATED TECHNOLOGY

Optical products can be used for a variety of purposes such as to reproduce a 3D image. Such products can be placed on decorative signs, labels, packaging, and consumer goods. Some optical products can be used as an anti-counterfeit feature, for example, on currency (e.g., a banknote). Holograms have traditionally been used as a counterfeit deterrent. However, this technology has become so widespread with hundreds if not thousands of holographic shops around the world that holograms are now viewed as having poor security. Optically variable inks and optically variable magnetic inks have also enjoyed for the past decade a high security place on banknotes. However, these products have now been simulated or have been even made from similar materials as the originals that these security elements are now being questioned as a high security feature. Motion type security elements have been adopted into banknotes, but even here, security has been compromised as this feature has also been used on commercial products. Thus, what is needed is a new security feature that the average person readily recognizes, has no resemblance to holograms or inks, is readily verified as to its authenticity, is difficult to counterfeit, is easily manufactured in quantity and can be readily incorporated into an item such as a banknote.

Manufacturing optical products, e.g., in relatively large quantities for commercial use, can utilize a master to fabricate the optical product. A master can be either a negative or positive master. For example, a negative master can form a surface of the optical product that is complementary to the surface of the master. As another example, a positive master can provide a surface for the optical product that is substantially similar to the surface of the master.

### SUMMARY

Various embodiments described herein comprise a master for fabricating an optical product. The optical product can be configured, when illuminated, to reproduce by reflected light, a 3D image of at least a part of a 3D object. The master can comprise a first surface and a second surface opposite the first surface. The second surface can comprise a plurality of portions. Each portion can correspond a point on a surface of the 3D object. Each portion can comprise features corresponding to non-holographic elements on the optical product. A gradient (e.g., slope) in the features can correlate to an inclination of the surface of the 3D object at the corresponding point. In addition, an orientation of the features can correlate to an orientation of the surface of the 3D object at the corresponding point.

Certain embodiments described herein also include an optical product configured, when illuminated, to reproduce by reflected light, a 3D image of at least a part of a 3D object. The optical product can comprise a first surface and a second surface opposite the first surface. The second surface can comprise a plurality of portions. Each portion can correspond to a point on a surface of the 3D object. Each portion can comprise non-holographic features configured to produce at least part of the 3D image of the 3D object without relying on diffraction. A gradient in the non-holographic features can correlate to an inclination of the surface of the 3D object at the corresponding point. In addition, an orientation of the non-holographic features can correlate to an orientation of the surface of the 3D object at the corresponding point.

Furthermore, various embodiments described herein include a method for manufacturing a master for fabricating an optical product. The optical product can be configured, when illuminated, to reproduce by reflected light, a 3D image of at least a part of a 3D object. The method can comprise providing a 2D data file configured to describe the 3D image. The data file can comprise a plurality of portions. Each portion can correspond to one or more points on a surface of the 3D object. Each portion can comprise features of intensity corresponding to non-holographic elements on the optical product. A gradient in intensity can correlate to an inclination of the surface of the 3D object at the one or more corresponding points. In addition, an orientation of the features can correlate to an orientation of the surface of the 3D object at the one or more corresponding points. The method can also comprise manufacturing the master based at least in part on the 2D data file.

Certain embodiments described herein of a master, optical product, and/or data file can also include one or more of the following (1) a majority of the plurality of portions comprising a single non-holographic feature, (2) a majority of the plurality of portions comprising one or more non-holographic features discontinuous with one or more non-holographic features in surrounding adjacent portions, (3) a majority of the plurality of portions comprising one or more non-holographic features having different orientations as one or more non-holographic features in surrounding adjacent portions, and/or (4) one or more non-holographic features comprising non-linear features when viewed in a cross-section. In some embodiments, each portion comprising one or more non-holographic features can be configured to produce at least part of the image without relying on diffraction (1) at a viewing angle at least between 20 degrees to 160 degrees relative to a plane of the optical product as the optical product is tilted and (2) at a viewing angle at least between 20 degrees to 90 degrees relative to the plane of the optical product as the optical product is rotated at least throughout the range of 90 degrees (rotated at least throughout the range of 180 degrees, rotated at least throughout the range of 270 degrees, or rotated at least throughout the range of 360 degrees) in the plane of the optical product.

In some embodiments, the size of the portion may assist in reducing iridescence or a change in color with change in angle of view or change in angle of illumination such as results when tilting the product with respect to the viewer and/or source of illumination. Accordingly, in various embodiments, the optical product does not exhibit a rainbow-like array of displayed colors where colors simultaneously appear in the order of a rainbow. Also, in some embodiments, the color of light emanating from the product does not appear to change when tilting the product or the viewer with respect to the product or the illumination with respect to the product, for example, in order of progressively increasing wavelength or in order of progressively decreasing wavelength (e.g., in progressive order of the arrangement of colors in the rainbow).

The size of the portion may be sufficiently large to produce light that can pass through a circular pupil 5 mm in diameter located 24 inches from the product that includes a plurality of colors that mix together to form white light. Accordingly, for a person viewing the product with their eye positioned 24 inches from the product and having a pupil of 5 mm in diameter, light from the product will enter the eye and be mixed together to form white light. The person thus does not see iridescence or change in color with change in angle of view or angle of illumination or tilt of the product. Other factor besides the size of the portion may contribute to this effect, even if the size of the portion is not sufficiently large on its own to cause this lack of iridescence. For example, not having multiple grating like features in a single portion may reduce this effect. Similarly, having a large number or percentage of portions that do not have multiple grating like features but instead have a single surface may contribute to reducing iridescence or change in color with angle. Additionally, having features with a curved surface within the portion may help counter the iridescent effect. The curved features may, for example, enhance mixing of different colors so that white light is sensed by the viewer. Even if multiple features are included in a portion, these features may be curved and this curvature may potentially reduce the iridescence. Also, the amount of portions that have features that are oriented differently from each other may be increased and the amount of portions that have a shift in phase or otherwise introduce a discontinuity may be increased, possibly resulting in increased mixing of color components and reducing this effect of diffractive spectral dispersion

Various embodiments disclosed herein can be used for security documents, in particular, as security threads in bank notes or as a patch or as a window. Other security items such as passports, ID cards, chip cards, credit cards, stock certificates and other investment securities, vouchers, admission tickets and commercial packages that protect items of value such as CD's, medicinal drugs, car and aircraft parts, etc. may also be protected against counterfeiting using the concepts and embodiments described herein.

### BRIEF DESCRIPTION OF THE DRAWINGS

FIG. 1A schematically illustrates an example master and optical product in accordance with certain embodiments described herein.

FIG. 1B schematically illustrates a top view of the surface of a master for fabricating an optical product in accordance with certain embodiments described herein.

FIG. 1C schematically illustrates the inclination and orientation of a surface of a 3D object at a point on the surface.

FIG. 1D is another example optical product 10′ in accordance with certain embodiments described herein.

FIG. 1E is another example optical product 10′ in accordance with certain embodiments described herein.

FIG. 2 illustrates an example method to manufacture a master for fabricating an optical product in accordance with certain embodiments described herein.

FIG. 2A illustrates an example method that can be used to manufacture a surface relief diffuser.

FIGS. 2B-2C illustrate example methods to manufacture a master for fabricating an optical product in accordance with certain embodiments described herein.

FIGS. 3A-3B illustrate example 2D data files in accordance with certain embodiments disclosed herein.

FIGS. 3C-3D illustrate example features on a data file and the corresponding features on the surface of a master for fabricating an optical product in accordance with certain embodiments disclosed herein.

FIG. 4A illustrates another example 2D data file in accordance with certain embodiments disclosed herein.

FIG. 4B illustrates an example normal map used to generate the data file shown in FIG. 4A.

FIG. 4C illustrates the 3D image reproduced by an optical product generated from a master produced using the data file shown in FIG. 4A.

### DETAILED DESCRIPTION

In various embodiments, a master (e.g., a master and/or daughter shim) for fabricating an optical product is provided. The optical product, when illuminated, can reproduce an overt 3D image (e.g., an image that appears 3D to the naked eye) of a 3D object. Compared to ink printed images, the reflective surface of various embodiments of the optical product can produce a brighter mirror-like image produced by reflecting (or refracting) light incident on the surface. In certain such embodiments, the surface normals of the 3D object are mimicked as surface relief on the master and/or optical product. The surface relief on the master and/or optical product can be thinner than the 3D object, yet produce the same appearance of the 3D object. This property is similar to Fresnel lenses, where the surface relief allows a lens to be produced that is thinner than a comparable non-Frensel lens. Unlike Fresnel lenses, however, certain embodiments disclosed herein are not limited in the type of 3D object that can be reproduced (e.g., linear and regularly shaped objects). As such, realistic and bright 3D images can be produced on relatively thin films (e.g., 30 μm and less in thickness, 25 μm and less in thickness, 15 μm and less in thickness, or any ranges in between these values). Thin films may be advantageous for different applications. In addition, special effects can be integrated into the image. In various embodiments described herein, the optical product can advantageously be used in applications for flexible packaging, brand identification, tamper evident containers, currency (e.g., a banknote), decoding messages, authenticity, and security, etc. Some security applications include incorporation of small detailed features, incorporation of non-symmetrical features, incorporation of machine readable features, etc.

In certain embodiments, the optical product can be incorporated into an item as an embedded feature, a hot stamp feature, a windowed thread feature, or a transparent window feature. For example, on an item such as a banknote, the optical product can be a patch, a window, or a thread. The optical product can have a thickness of less than 30 μm, less than 25 μm, or less than 15 μm. In various embodiments, the image can appear 3D by the naked eye.

In some embodiments, the image can be seen at a viewing angle between 20 degrees to 160 degrees, between 15 degrees to 165 degrees, between 10 degrees to 170 degrees, between 5 degrees to 175 degrees, or between 0 degrees to 180 degrees relative to the plane of the item (e.g., relative to the banknote plane) as the item is tilted. For example, the image can be viewable within one or more of these viewing angle ranges relative to the plane of the item.

In some embodiments, the image can be seen at a viewing angle between 20 degrees to 90 degrees, between 15 degrees to 90 degrees, between 10 degrees to 90 degrees, between 5 degrees to 90 degrees, or between 0 degrees to 90 degrees relative to the normal of the item as the item is rotated the normal of the item (e.g., in the plane of the item). For example, the image can be viewable and/or visible within one or more of these viewing angle ranges as the item is rotated (e.g., rotated at least throughout the range of 90 degrees, rotated at least throughout the range of 180 degrees, rotated at least throughout the range of 270 degrees, or rotated at least throughout the range of 360 degrees) about the normal of the item (e.g., in the plane of the item).

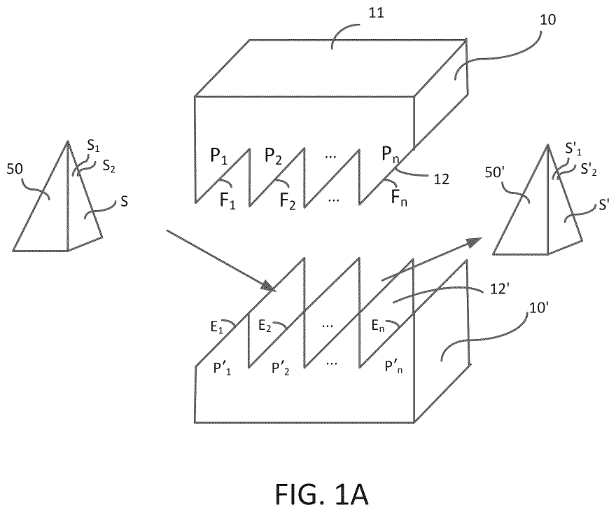

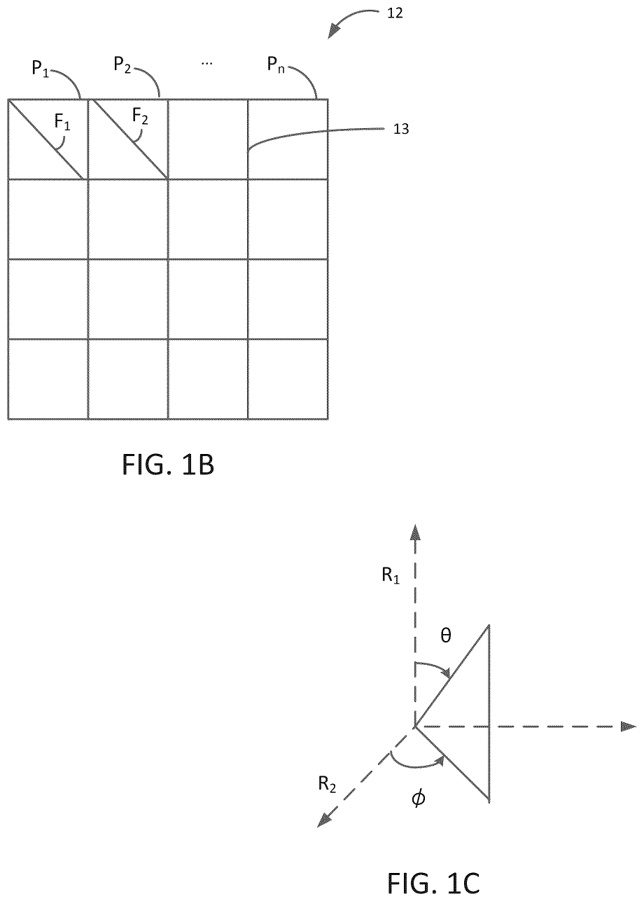

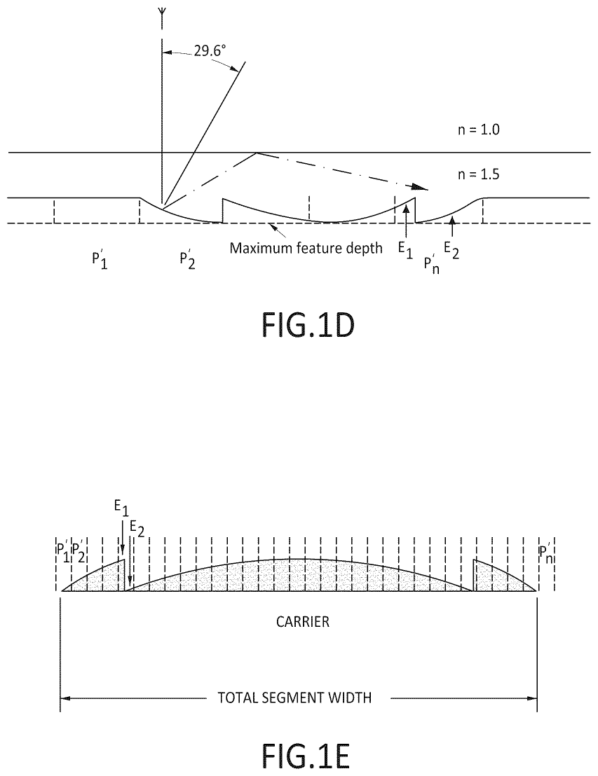

FIG. 1A schematically illustrates an example master 10 for fabricating an optical product 10′ in accordance with certain embodiments described herein. In various embodiments, the master 10 can include a first surface 11 and a second surface 12 opposite the first surface 11. As shown in FIG. 1A, the second surface 12 can include a plurality of portions P₁, P₂, . . . Pₙ. Each portion Pₙ can correspond to a plurality of portions P′₁, P′₂, . . . P′ₙ on the optical product 10′. The plurality of portions P′₁, P′₂, . . . P′ₙ on the optical product 10′ can also be referred to as a cell, pixel, or a tile. Each portion P′ₙ can have a length between 30 μm and 100 μm, between 35 μm and 55 μm, or between 40 μm and 50 μm. Each portion P′ₙ can have a width between 30 μm and 100 μm, between 35 μm and 55 μm, or between 40 μm and 50 μm. Accordingly, in various embodiments, the aspect ratio of each portion P′ₙ can be 1:1 or 1:1.1.

Each portion Pₙ of the master 10 (and each portion P′ₙ of the optical product 10′) can correspond to a point S₁, S₂, . . . Sₙ on a surface S of the 3D object 50. Each portion Pₙ can include features F₁, F₂, . . . Fₙ corresponding to elements E₁, E₂, . . . Eₙ, e.g., non-holographic elements, on the optical product 10′. A gradient (e.g., slope) in the features F₁, F₂, . . . Fₙ can correlate to an inclination (e.g., slope) of the surface S of the 3D object 50 at the corresponding point S₁, S₂, . . . Sₙ. In addition, an orientation of the features F₁, F₂, . . . Fₙ can correlate to an orientation of the surface S of the 3D object 50 at the corresponding point S₁, S₂, . . . Sₙ. Accordingly, with certain embodiments disclosed herein, an optical product 10′ fabricated using the example master 10 can be configured, when illuminated, to reproduce by reflected (or refracted) light, a 3D image 50′ (e.g., an image that appears 3D) of at least a part of a 3D object 50. The image can be observed by the naked eye and under various lighting conditions (e.g., specular, diffuse, and/or low light conditions).

The optical product 10′ can be used on a variety of products to reproduce a 3D image 50′ of at least a part of a 3D object 50. For example, the optical product 10′ can be placed on decorative signs, advertisements, labels (e.g., self-adhesive labels), packaging (e.g., consumer paper board packaging and/or flexible packaging), consumer goods, collectible cards (e.g., baseball cards), etc. The optical product 10′ can also be advantageously used for authenticity and security applications. For example, the optical product 10′ can be placed on currency (e.g., a banknote), credit cards, debit cards, passports, driver's licenses, identification cards, documents, tamper evident containers and packaging, bottles of pharmaceuticals, etc.

In various implementations, the optical product 10′ can be a reflective or transmissive device. For example, the optical product 10′ can include reflective material (e.g., reflective metal such as aluminum, copper, or silver disposed on the plurality of elements E₁, E₂, . . . Eₙ, or a transparent, relatively high refractive index material such as ZnS or TiO₂ disposed on the plurality of elements E₁, E₂, . . . Eₙ creating a semi-transmitting/partially reflective boundary). Depending on the thickness of the reflective material, the optical product 10′ can be reflective or transmissive. Depending on the thickness of the reflective material, the optical product 10′ can be partially reflective or partially transmissive. The thickness of the reflective material at which the optical product 10′ is reflective or transmissive can depend on the chemical composition of the reflective material.

Accordingly, in some embodiments, the optical product 10′ can include a reflective surface 12′ from which light can reflect from the elements E₁, E₂, . . . Eₙ to reproduce the image 50′ of the 3D object 50 or at least part of the 3D object 50. For example, the optical product 10′ can be made of a reflective metal (e.g., aluminum, copper, or silver), a semi-transparent metal, or a material (e.g., polymer, ceramic, or glass) coated with a reflective metal. Reflective coatings that employ non-metallic material can also be employed.

In some embodiments where the elements E₁, E₂, . . . Eₙ are coated with a reflective metal, the thickness of the coating layer can be greater than or equal to 40 nm such that the layer is opaque. Alternatively, the thickness of the reflective metal can be less than 40 nm such that the layer is semi-transparent (e.g., 30% transparent 40% transparent, 50% transparent, 60% transparent, 70% transparent, or any ranges inbetween these values, etc.). In reflective embodiments, the elements E₁, E₂, . . . Eₙ can reflect light towards or away from the observer's eye to reproduce the image 50′ the 3D object 50. For example, the elements E₁, E₂, . . . Eₙ can reflect light towards the observer's eye in bright areas, and reflect light away from the observer's eye in dark areas. In some embodiments, the slopes of the elements Eₙ can be configured to create the 3D depth perception of the image. For example, elements Eₙ with less steep slopes can cause light to reflect toward the observer's eye creating more brightness, while elements Eₙ with steeper slopes can cause light to reflect away from the observer's eye creating more darkness.

In some other embodiments (e.g., for a transmissive device), the optical product 10′ can include a layer (e.g., a coating) of a transparent, relatively high refractive index material such as, for example, ZnS or TiO₂. In some such embodiments, light can transmit through the material and can also reflect at each of the elements E₁, E₂, . . . Eₙ due to the presence of the relatively high index layer which can create index mismatch and results in Fresnel reflection. The relatively high index material can be up to a full visible wavelength in thickness in some embodiments. If a color tint is used, the relatively high index material can be up to a ¼ of a visible wavelength in thickness in some embodiments.

Furthermore, the optical product 10′ can include a protective covering, e.g., an organic resin, to protect the elements E₁, E₂, . . . Eₙ and/or any coating layer from corrosion from acidic or basic solutions or organic solvents such as gasoline and ethyl acetate or butyl acetate. In various implementations, the protective covering can also provide protection during subsequent processing steps and use of the optical product 10′ (e.g., during the manufacturing of currency and/or by general handling by the public).

In various embodiments, the optical product 10′ can be placed on or in another surface (e.g., as an embedded feature, a hot stamped feature such as a patch, a windowed thread feature, or a transparent window feature). In other embodiments, the optical product 10′ can be placed under another surface (e.g., laminated under a film and/or cast cured). In some embodiments, the optical product 10′ can be placed between two other surfaces (e.g., hot stamped on another surface and laminated under a film). Additional features associated with the optical product 10′ will become apparent with the disclosure herein of the master 10 for fabricating the optical product 10′.

The image 50′ of at least part of the 3D object 50 can be reproduced when the optical product 10′ is illuminated. In various embodiments, the image 50′ can be reproduced by a multitude of relatively small mirrors (e.g., each of the elements E₁, E₂, . . . Eₙ having both a length and width between 30 μm and 100 μm, between 35 μm and 55 μm, or between 40 μm and 50 μm) which can be curved (e.g., have a freeform curvature) or planar. For example, in some embodiments, a reflective surface of the optical product 10′ can provide a surface for specular reflection, such that the image 50′ can be produced by the reflected light (e.g., like a mirror). Accordingly, various embodiments can produce a bright, high quality image. Some embodiments can also utilize techniques for producing diffuse reflection, e.g., for special or desired effects. Furthermore, the image 50′ can be a substantially similar reproduction (e.g., with similar details), an approximate reproduction (e.g., with less details), and/or a scaled copy (e.g., scaled up or down in size) of the 3D object 50 or part of the 3D object 50.

In general, the 3D object 50 to be reproduced is not particularly limited and can advantageously include rotationally non-symmetrical and/or irregularly shaped objects, as well as symmetrical and/or regularly shaped objects. For example, the 3D object 50 can include one or more alphanumeric characters and/or symbols. For example, the 3D object 50 can include one or more text, one or more alphabetic characters, one or more numeric characters, one or more letters, one or more numbers, one or more symbols, one or more punctuation marks, one or more mathematical operators, etc. The 3D object 50 can also include one or more graphical images or logos, e.g., a company logo, a team logo, product branding designs, etc. Accordingly, the 3D object 50 can include irregularly shaped features in addition to planar and curved features. In some embodiments, the 3D object 50 can comprise animals, humans, plants or trees, landscapes, buildings, cars, boats, airplanes, bicycles, furniture, office equipment, sports equipment, foods, drinks, personal care items, flags, emblems, symbols like country, company or product symbols including trademarks, or parts thereof or groups or combination of these items with or without other items. The objects may be cartoon or artistic renditions. A wide range of other objects are possible.

As set forth herein, in various embodiments, the image 50′ can be seen at various viewing angles (e.g., between 20 degrees to 160 degrees, between 15 degrees to 165 degrees, between 10 degrees to 170 degrees, between 5 degrees to 175 degrees, or between 0 degrees to 180 degrees relative to the plane of the item (e.g., relative to the banknote plane). For example, when the example optical product 10′ is tilted, upon viewing the example optical product 10′ at different viewing angles (or upon different angles of illumination), different sets of elements E₁, E₂, . . . Eₙ can be seen by the observer to provide the different images of the 3D object.

In some embodiments, the image can be seen at a viewing angle between 20 degrees to 90 degrees, between 15 degrees to 90 degrees, between 10 degrees to 90 degrees, between 5 degrees to 90 degrees, or between 0 degrees to 90 degrees relative to the normal of the item as the item is rotated about the normal of the item. For example, the image can be viewable within one or more of these viewing angle ranges as the item is rotated (e.g., rotated at least throughout the range of 90 degrees, rotated at least throughout the range of 180 degrees, rotated at least throughout the range of 270 degrees, or rotated at least throughout the range of 360 degrees) about the normal of the item.

Furthermore, in certain embodiments, the image 50′ can be substantially without iridescence or change in color with angle. For example, in various embodiments, there are substantially no colors (e.g., rainbow effect), other diffractive colors, or ghosting effects in the image 50′. For example, in certain embodiments, the size of the portions P′₁, P′₂, . . . P′ₙ can have a length and width between 30 μm and 100 μm, between 35 μm and 55 μm, or between 40 μm and 50 μm. In some such embodiments (e.g., between 40 μm and 50 μm), the portions P′ₙ may be small enough such that the portions P′ₙ are not resolvable by a human observer under normal viewing conditions (e.g., a reading distance of 18 to 24 inches between the eye and the item to be viewed). In addition, without being bound by theory, the portions P′ₙ may be big enough such that the cone of light passing through the pupil (e.g., 5 mm in diameter) is small enough such that the eye may see a majority of the colors mixed as white light at a distance of 18-24 inches.

As another example, in some embodiments, a majority (e.g., greater than 50%, greater than 55%, greater than 60%, greater than 65%, greater than 70%, greater than 80%, greater than 90%, and any ranges in between these values) of the plurality of portions P′₁, P′₂, . . . P′ₙ on the optical product 10′ can include a single non-holographic element E₁ (as opposed to a plurality of spaced apart non-holographic elements Eₙ that may resemble a grating-like feature). Without being bound by theory, grating-like features can cause light to be dispersed with some of the light collected by the pupil of the eye. If the period of the grating-like feature is small enough, the light captured by the pupil may appear as a color. Accordingly, in various embodiments of the optical product 10′ that have a majority of the plurality of portions P′₁, P′₂, . . . P′ₙ having not more than a single non-holographic reflective or refractive element E₁, unwanted color caused by grating-like features may possibly be substantially reduced and/or eliminated. Similarly, color change with angle of tilt can be reduced. In some embodiments, at least 20%, at least 30%, at least 40%, at least 50%, at least 60%, at least 70%, at least 80%, at least 90%, or any ranges in between these values) of the plurality of portions P′₁, P′₂, . . . P′ₙ on the optical product 10′ can include a single non-holographic element E₁. In various embodiments, the single element may be slowly varying and/or substantially flat. In certain embodiments, the maximum average slope per portion with a single feature is less than ½, less than ⅓, less than ¼, less than ⅕, less than ⅙, potentially flat, and any ranges in between these values depending on feature height and width.

In addition, in portions P′ₙ having a plurality of non-holographic elements E₁, E₂, . . . Eₙ(e.g., grating-like features), the elements Eₙ can be discontinuous and/or having different orientation with non-holographic elements E₁, E₂, . . . Eₙ in surrounding adjacent portions P′ₙ. Without being bound by theory, the discontinuity and/or different orientations between grating-like features can cause a lateral shift of the grating-like feature. The lateral shift may cause the color spectrum to shift as well (e.g., from red to blue to green). The colors may combine on the retina providing an average white irradiance distribution. Accordingly, in embodiments of the optical product 10′ that have a plurality of portions P′₁, P′₂, . . . P′ₙ including a plurality of non-holographic element Eₙ, unwanted color cause by grating-like features may possibly be substantially reduced and/or eliminated. Similarly, color change with angle of tilt can be reduced.

Accordingly, certain embodiments of the optical product 10′ can utilize a certain portion P′ₙ size, a single non-holographic element E₁ in a portion P′ₙ, discontinuous and/or differently orientated elements Eₙ to produce images that may be substantially without iridescence or change in color with angle. The application of these features can be dependent on the image to be formed.

Various embodiments described herein can create a 3D image primarily by the reflection of light without relying on diffraction (e.g., without relying on holographic or grating diffraction). In other embodiments, the optical product 10′ can include surfaces which additionally include features from which light can diffract, e.g., at surface defects, at discontinuities at borders, and/or via incorporation of diffractive or holographic elements. Such diffractive or holographic features can be combined with the surface features disclosed herein that produce an image of a 3D object using reflection (or possibly refraction, e.g., in transmission) without relying on diffraction.

In various embodiments, the master 10 can be either a negative or positive master. Whether as a negative or positive master, the method to produce the master 10 is not particularly limited. For example, the features F₁, F₂, . . . Fₙ on surface 12 of the master 10 can be produced using any technique known in the art or yet to be developed, including but not limited to photolithography (e.g., UV or visible light), electron beam lithography, and ion beam lithography to name a few. Additionally, the materials that can be used to manufacture the master 10 are not particularly limited and can include glasses, ceramics, polymers, metals, etc.

As a negative master, the master 10 can form a surface 12′ of the optical product 10′ that is complementary to the surface 12 of the master 10. For example, as shown in FIG. 1A, the features F₁, F₂, . . . Fₙ on the surface 12 of the master 10 can be the inverse of the elements E₁, E₂, . . . Eₙ on the surface 12′ of the optical product 10′. In such embodiments, the master 10 can be used to form the optical product 10′. For example, the master 10 can be used to emboss the elements E₁, E₂, . . . Eₙ onto a metal sheet, a polymeric substrate such as a thermoformable polymer, or a UV curable photoresist layer such as a UV curable resin, or to injection mold the elements E₁, E₂, . . . Eₙ onto a polymer.

As another example, as a positive master, the master 10 can provide a surface 12′ for the optical product 10′ that is substantially similar to the surface 12 of the master 10. The features F₁, F₂, . . . Fₙ on the surface 12 of the master 10 can be substantially similar to the elements E₁, E₂, . . . Eₙ on the surface 12′ of the optical product 10′. In some such embodiments, the positive master 10 can provide a model for the optical product 10′. In other such embodiments, the positive master 10 can be used to create an inverse image of the 3D object 50. In addition, the positive master 10 can be used to fabricate one or more negative masters.

Although the master 10 is shown producing a product directly, in certain embodiments the master 10 is employed to produce one or more other masters (e.g., daughter shims) or intermediate surfaces that can in turn be used to produce a product. For example a first negative master can be used to produce a second master that is a positive master. The second positive master can be used to make a third negative master. The third negative master can be used to produce a fourth positive master. The fourth positive master can be used to produce a product. Accordingly, a tooling tree of masters (e.g., four, five, six, etc. generations deep) can be produced.

Certain embodiments of the optical product 10′ disclosed herein can be advantageously manufactured on a large industrial scale. Some embodiments can be manufactured by embossing the elements E₁, E₂, . . . Eₙ into an UltraViolet (UV) curable resin coated onto various polymeric substrates, such as, for example, polyethylene terephthalate (PET), oriented polypropylene (OPP), low density polyethylene (LDPE), linear low density polyethylene (LLDPE), polypropylene (PP), polyvinyl chloride (PVC) polycarbonate (PC) or any other type of plastic film or carrier. For thermoformable plastics such as PVC and PC, the elements E₁, E₂, . . . Eₙ can be embossed directly into the substrate without the UV curable layer. In various embodiments, the polymeric substrate can be clear. The polymeric substrates can have a thickness less than or equal to 30 microns, less than or equal to 25 microns, or less than or equal to 15 microns. Some such polymeric substrates having elements E₁, E₂, . . . Eₙ can be formed into security threads that can be incorporated into a banknote having a paper thickness of 100 microns.

With continued reference to FIG. 1A, the master 10 can include a first surface 11 and a second surface 12. The first surface 11 is shown for simplicity as a planar surface. However, the shape of the first surface 11 is not particularly limited. The second surface 12 can be opposite the first surface 11. The second surface 12 can include a plurality of portions P₁, P₂, . . . Pₙ. In some embodiments, the plurality of portions P₁, P₂, . . . Pₙ can form a single cell (e.g., a mono-cell). In other embodiments, the plurality of portions P₁, P₂, . . . Pₙ can form a plurality of cells. For example, each of the plurality of portions P₁, P₂, . . . Pₙ can form a cell of the plurality of cells. The number of cells is not particularly limited and can depend on factors such as size and resolution of the image to be reproduced. In various embodiments, the portions P₁, P₂, . . . Pₙ can form a pixelated surface. For simplicity, only one row of portions P₁, P₂, . . . Pₙ is shown in FIG. 1A. However, certain embodiments can include additional rows and columns of portions P₁, P₂, . . . Pₙ For example, as shown in FIG. 1B, the portions P₁, P₂, . . . Pₙ can include a plurality of rows and columns spanning across the surface 12 of the master 10. For simplicity, only the first row is labeled as P₁, P₂, . . . Pₙ. Furthermore, although FIG. 1B shows a 4×4 array of portions P₁, P₂, . . . Pₙ, the numbers of rows, columns, and portions P₁, P₂, . . . Pₙ are not particularly limited.

As also shown in FIG. 1B, in some embodiments, borders 13 can surround at least part of the portions P₁, P₂, . . . Pₙ. The borders 13 can substantially surround a portion Pₙ, or can surround just part of a portion Pₙ. In some embodiments, discontinuities can extend around all or substantially all of the portion Pₙ. In other embodiments, discontinuities may extend on just a part of the portion Pₙ. The borders 13 can help define the size and shape of the portions P₁, P₂, . . . Pₙ in some embodiments. However, the size and shape of the portions P₁, P₂, . . . Pₙ are not particularly limited. For example, some of the portions P₁, P₂, . . . Pₙ can comprise a symmetrical shape. For example, the symmetrical shape can include a rectangle, a square, a rhombus, an equilateral triangle, an isosceles triangle, a regular polygon (e.g., a regular pentagon, a regular hexagon, a regular octagon, etc.), to name a few. The symmetrical shape can also include curvature, e.g., a circle, an ellipse, etc. In other embodiments, some of the portions P₁, P₂, . . . Pₙ can comprise a non-symmetrical shape, e.g., a non-rotationally symmetrical shape, and/or an irregular shape. In some embodiments, some of the portions P₁, P₂, . . . Pₙ can have a shape that is substantially the same as other portions P₁, P₂, . . . Pₙ. In some embodiments, at least 20%, at least 30%, at least 40%, at least 50%, at least 60%, at least 70%, at least 80%, at least 90% (or any range in between these percentages) of the portions P₁, P₂, . . . Pₙ can have the same shape, size, or both. In other embodiments, some of the portions P₁, P₂, . . . Pₙ can have a shape that is different from other portions P₁, P₂, . . . Pₙ.

Arrangement of the portions P₁, P₂, . . . Pₙ is not particularly limited. For example, whether with or without borders, whether symmetrically shaped or non-symmetrically shaped, or whether regularly or irregularly shaped, the portions P₁, P₂, . . . Pₙ can form a periodic array. In other embodiments, whether with or without borders, whether symmetrically shaped or non-symmetrically shaped, or whether regularly or irregularly shaped, the portions P₁, P₂, . . . Pₙ can form an aperiodic array. In yet other embodiments, the portions P₁, P₂, . . . Pₙ can form a combination of periodic and aperiodic arrays.

With continued reference to FIG. 1A, each portion Pₙ can correspond to a point S₁, S₂, . . . Sₙ on the surface S of the 3D object 50, and each portion Pₙ can include one or more features F₁, F₂, . . . Fₙ. For simplicity, the features F₁, F₂, . . . Fₙ shown in FIG. 1A appear linear and substantially similar to each other. However, the features F₁, F₂, . . . Fₙ can vary in number, size, shape, and orientation.

In certain embodiments, the features F₁, F₂, . . . Fₙ can include linear and/or curved features, for example as seen from a top or front view. In some embodiments, the features F₁, F₂, . . . Fₙ can include facets, such as linear or curved saw tooth shaped features. The size of the features F₁, F₂, . . . Fₙ are not particularly limited. However, from a manufacturing and economic perspective, in some embodiments, a smaller height (e.g., 0 μm to 10 μm) can be advantageous to reduce the amount of material used. Accordingly, in some embodiments, the heights of the features F₁, F₂, . . . Fₙ can be from close to 0 μm to 0.1 μm (e.g., 0 nm to 100 nm, 1 nm to 75 nm, or 1 nm to 50 nm), from close to 0 μm to 1 μm (e.g., 0 nm to 1000 nm, or 1 nm to 500 nm), from close to 0 μm to 5 μm (e.g., 1 nm to 5 μm, 10 nm to 5 μm, 50 nm to 5 μm, 75 nm to 5 μm, 0.1 μm to 5 μm, 0.5 μm to 5 μm, or 1 μm to 5 μm), or from close to 0 μm to 8 μm (e.g., 1 nm to 8 μm, 10 nm to 8 μm, 50 nm to 8 μm, 75 nm to 8 μm, 0.1 μm to 8 μm, 0.5 μm to 8 μm, or 1 μm to 8 μm), or from close to 0 μm to 10 μm (e.g., 1 nm to 10 μm, 10 nm to 10 μm, 50 nm to 10 μm, 75 nm to 10 μm, 0.1 μm to 10 μm, 0.5 μm to 10 μm, or 1 μm to 10 μm). In other embodiments, the heights of the features F₁, F₂, . . . Fₙ can go up to 15 μm, up to 20 μm, up to 25 μm, or any ranges from 1 μm, 2 μm, or 3 μm up to 25 μm. In yet other embodiments, the heights of the features F₁, F₂, . . . Fₙ can go up to 50 μm if needed, e.g., depending on the desired size of the 3D image to be reproduced.

Furthermore, in some embodiments, the lateral dimensions of the features F₁, F₂, . . . Fₙ are not particularly limited, but can depend on the details of the 3D object. For example, for text, the lateral dimensions of the features F₁, F₂, . . . Fₙ can be less than 1 μm. Accordingly, the lateral dimensions of the features F₁, F₂, . . . Fₙ can be from close to 0 μm to 0.1 μm (e.g., 0 nm to 100 nm, 1 nm to 75 nm, or 1 nm to 50 nm), from close to 0 μm to 1 μm (e.g., 0 nm to 1000 nm, or 1 nm to 500 nm), from close to 0 μm to 5 μm (e.g., 1 nm to 5 μm, 10 nm to 5 μm, 50 nm to 5 μm, 75 nm to 5 μm, 0.1 μm to 5 μm, 0.5 μm to 5 μm, or 1 μm to 5 μm), or from close to 0 μm to 8 μm (e.g., 1 nm to 8 μm, 10 nm to 8 μm, 50 nm to 8 μm, 75 nm to 8 μm, 0.1 μm to 8 μm, 0.5 μm to 8 μm, or 1 μm to 8 μm), or from close to 0 μm to 10 μm (e.g., 1 nm to 10 μm, 10 nm to 10 μm, 50 nm to 10 μm, 75 nm to 10 μm, 0.1 μm to 10 μm, 0.5 μm to 10 μm, or 1 μm to 10 μm).

In various embodiments, a lateral distance between two features can be defined in some embodiments as a pitch. In some embodiments, the pitch between features within a portion Pₙ can be substantially the same within the portion Pₙ. For example, in various embodiments, in portion P₁ of the portions P₁, P₂, . . . Pₙ, the feature F₁ can comprise a plurality of features that form a periodic array such that the pitch is substantially the same within portion P₁. In addition, in some embodiments, the features F₁, F₂, . . . Fₙ among the multiple portions P₁, P₂, . . . Pₙ, can form a periodic array such that the pitch is substantially the same among the portions P₁, P₂, . . . Pₙ. In other embodiments, the features could be chirped and form an aperiodic array such that the pitch may be different among multiple portions P₁, P₂, . . . Pₙ. However, although the pitch may be different for different portions P₁, P₂, . . . Pₙ, the pitch can be slowly varying (e.g., less than 15% change per lateral distance, less than 12% change per lateral distance, less than 10% change per lateral distance, less than 8% change per lateral distance, less than 5% change per lateral distance, less than 3% change per lateral distance, or less than 1% change per lateral distance) among the portions P₁, P₂, . . . Pₙ. In some embodiments, the pitch may uniformly change across multiple portions P₁, P₂, . . . Pₙ. In other embodiments, the features could be chirped within a portion Pₙ such that the pitch may be different within the portion Pₙ. In some such embodiments, the pitch within the portion Pₙ may slowly vary (e.g., less than 15% change per lateral distance, less than 12% change per lateral distance, less than 10% change per lateral distance, less than 8% change per lateral distance, less than 5% change per lateral distance, less than 3% change per lateral distance, or less than 1% change per lateral distance). In some embodiments, the pitch may uniformly change with the portion Pₙ. The pitch in certain embodiments can be between 1 μm and 100 μm, between 1 μm and 75 μm, between 1 μm and 50 μm, or between 1 μm and 25 μm.

With continued reference to FIG. 1A, the features F₁, F₂, . . . Fₙ can correspond to elements E₁, E₂, . . . Eₙ on the optical product 10′, and since the optical product 10′ is configured to reproduce the 3D object 50, aspects of the features F₁, F₂, . . . Fₙ can correlate to aspects of the surface S of the 3D object 50 at the corresponding point S₁, S₂, . . . Sₙ. For example, a gradient (e.g., slope) in the features F₁, F₂, . . . Fₙ can correlate to an inclination of the surface S of the 3D object 50 at the corresponding point S₁, S₂, . . . Sₙ. For example, in various embodiments, each feature can include a slope. A slope of the feature F₁ can correlate to the inclination of the surface S of the 3D object 50 at the corresponding point S₁. As shown in FIG. 1C, the slope of the feature F₁ can correlate to the polar angle θ₁ from reference line R₁ of the 3D object 50. Accordingly, the slopes of the features F₁, F₂, . . . Fₙ can mimic the surface normals of the 3D object 50.

Various embodiments can advantageously have a uniform gradient (e.g., uniform slope) within each portion Pₙ such that the gradient is a single value (e.g., a single polar angle θₙ) at the corresponding point Sₙ on the surface S of the 3D object 50. In other embodiments, the feature Fₙ within a portion Pₙ includes a plurality of features, and the features within the portion Pₙ may have more than one gradient (e.g., different slopes). In such embodiments, the average gradient (e.g., average slope) of the features within the portion Pₙ can correlate to the inclination of the surface S of the 3D object 50 at the corresponding point Sₙ.

In some embodiments, varying the slopes within and/or among portions P₁, P₂, . . . Pₙ can create contrast on the surface and therefore, on the image 50′. Furthermore, varying at least one of the height of features, pitch between features (e.g., lateral distance between two features), and slope of the features in one or more portions P₁, P₂, . . . Pₙ can be used in authenticity and security applications. For example, one can intentionally vary the pitch within one or more portions Pₙ, but maintain the given slopes. The image 50′ of the 3D object 50 would be reproduced, yet upon closer inspection of the presence of the intentional variation within one or more portions P₁, P₂, . . . Pₙ, authenticity can be verified. Other variations are possible.

In various embodiments, the orientation of features F₁, F₂, . . . Fₙ can correlate to an orientation of the surface S of the 3D object 50 at the corresponding point S₁, S₂, . . . Sₙ. For example, an orientation of the feature F₁ can correlate to the orientation of the surface S of the 3D object 50 at the corresponding point S₁. As shown in FIG. 1C, the orientation of the feature F₁ can correlate to the azimuth angle φ₁ from reference line R₂ of the 3D object 50. Various embodiments can advantageously have a uniform orientation within each portion Pₙ, such that the orientation is a single value (e.g., a single azimuth angle φₙ) at the corresponding point Sₙ on the surface S of the 3D object 50. In other embodiments, the feature Fₙ within a portion Pₙ includes a plurality of features, and the features within the portion Pₙ may have more than one orientation (e.g., different orientations). In such embodiments, the average orientation of the features within the portion Pₙ can correlate to the orientation of the surface S of the 3D object 50 at the corresponding point Sₙ. Furthermore, the orientation of the features within and among the portions P₁, P₂, . . . Pₙ, can slowly vary (e.g., less than 15% change per lateral distance, less than 12% change per lateral distance, less than 10% change per lateral distance, less than 8% change per lateral distance, less than 5% change per lateral distance, less than 3% change per lateral distance, or less than 1% change per lateral distance) within and among the portions P₁, P₂, . . . Pₙ.

In some embodiments, where a feature F₁ includes multiple features within a portion, the features can appear discontinuous with other features within the portion. In some embodiments where the surface 12 of the master 10 is pixelated (e.g., having a plurality of cells), the features F₁, F₂, . . . Fₙ can appear discontinuous with features in surrounding adjacent portions. In other embodiments, the portions P₁, P₂, . . . Pₙ can form a single cell or a mono-cell. In some such embodiments, the features F₁, F₂, . . . Fₙ can appear continuous and smoothly varying depending on the shape. In other such embodiments, the features F₁, F₂, . . . Fₙ can appear discontinuous due to discontinuities in the 3D object 50.

In some embodiments, the features F₁, F₂, . . . Fₙ can comprise linear features corresponding to a substantially smooth region of the surface S of the 3D object 50. The features F₁, F₂, . . . Fₙ can also comprise non-linear features, e.g., curved features as seen from a top or front view, corresponding to a curved region of the surface S of the 3D object 50, e.g., instead of flat facets. In some embodiments, features F₁, F₂, . . . Fₙ that are linear can be used to correspond to a curved region of the surface S of the 3D object 50. In some such embodiments, linear features on a master 10 can be used to represent a curved region by using a piecewise approximation function (e.g., a piecewise linear function such as a function comprising straight line sections). In some other embodiments, features F₁, F₂, . . . Fₙ that are non-linear can be used to correspond to a substantially smooth region of the surface S of the 3D object 50. In some such embodiments, non-linear features on a master 10 can be used to represent smooth regions on the surface S of the 3D object because the features F₁, F₂, . . . Fₙ can correspond to relatively small sized features on the optical product 10′. For example, the pitch and/or texture on the optical product 10′ can be between 1 μm and 100 μm, between about 1 μm and about 75 μm, between about 1 μm and about 50 μm, or between about 1 μm and about 25 μm.

With continued reference to FIG. 1A, as described herein, the features F₁, F₂, . . . Fₙ can correspond to aspects of the surface S of the 3D object 50 and can also correspond to elements E₁, E₂, . . . Eₙ on the optical product 10′ such that the optical product 10′ can reproduce an image 50′ of the 3D object 50. In various embodiments, the elements E₁, E₂, . . . Eₙ on the optical product 10′ can be non-holographic. For example, the elements E₁, E₂, . . . Eₙ do not need to rely on holography (e.g., effects based on diffraction and/or based on optical interference) to render a 3D image 50′ of the 3D object 50. In some such embodiments, the features F₁, F₂, . . . Fₙ on the surface 12 of the master 10 can include non-sinusoidal features or non-quasi-sinusoidal features. In general, sinusoidal or quasi-sinusoidal features can be diffractive with +/− orders of equal intensity that generate a twin image. One positive order and one negative order can share the incident light and result in a simultaneous twin image with counter-intuitive movement of one image with respect to the other. Such effects may be non-ideal. In some embodiments that include non-sinusoidal or non-quasi-sinusoidal features, the features F₁, F₂, . . . Fₙ on the surface 12 of the master 10 can include other shapes, such as saw toothed shapes as described herein.

Although various embodiments described herein do not necessarily rely on holography to reproduce an image, some embodiments can include diffractive or holographic features (e.g., less than about 50% of the surface area, less than about 40% of the surface area, less than about 30% of the surface area, less than about 20% of the surface area, less than about 10% of the surface area, less than about 5% of the surface area, less than about 3% of the surface area, less than about 2% of the surface area, or less than about 1% of the surface area) to be used in conjunction with the non-holographic elements E₁, E₂, . . . Eₙ described herein. For example, in some embodiments, the second surface 12 of the master 10 can further comprise features corresponding to holographic elements on the optical product 10′ in one or more portions P₁, P₂, . . . Pₙ. In other embodiments, a holographic layer can be added over or under the surface 12′ of the optical product 10′.

FIG. 1D is another example optical product 10′ in accordance with certain embodiments described herein. As shown in FIG. 1D, the optical product 10′ can include a plurality of portions P′₁, P′₂, . . . P′ₙ. Each portion P′ₙ can include elements E₁, E₂, . . . Eₙ, e.g., non-holographic elements, on the optical product 10′. In some such embodiments, the elements E₁, E₂, . . . Eₙ can be embossed on the bottom surface of the substrate, e.g. UV curable resin having a refractive index of 1.5. The elements E₁, E₂, . . . Eₙ can be coated with a reflective coating. The elements E₁, E₂, . . . Eₙ may then be embedded between the substrate and the item to which the optical product 10′ is attached. As described herein, the slopes of the elements E₁, E₂, . . . Eₙ can be configured to create the 3D depth perception of the image. For example, elements E₁, E₂, . . . Eₙ with less steep slopes can cause light to reflect toward the observer's eye creating more brightness, while elements E₁, E₂, . . . Eₙ with steeper slopes can cause light to reflect away from the observer's eye creating more darkness. In this example of an embedded optical product 10′, elements E₁, E₂, . . . Eₙ with steep enough slopes can cause light to be totally internally reflected within the substrate (which has a higher index than the surrounding medium), and creating even more darkness.

FIG. 1E is another example optical product 10′ in accordance with certain embodiments described herein. As shown in FIG. 1E, the optical product 10′ can include a plurality of portions P′₁, P′₂, . . . P′ₙ. Each portion P′ₙ can include elements E₁, E₂, . . . Eₙ, e.g., non-holographic elements, on the optical product 10′. As described herein, utilizing embodiments of the optical product 10′ having elements E₁, E₂, . . . Eₙ (or masters having features F₁, F₂, . . . Fₙ) with smaller height can be advantageous to reduce the amount of material used. However in cases where height is less important, certain embodiments can utilize elements E₁, E₂, . . . Eₙ with slowly varying surfaces (e.g., slopes) creating a substantially contiguous surface from one portion P′ₙ to another. In various embodiments, the number of substantially contiguous portions can include at least two, three, four, five, eight, ten, fifteen, twenty, or more, or be in any range in between these values.

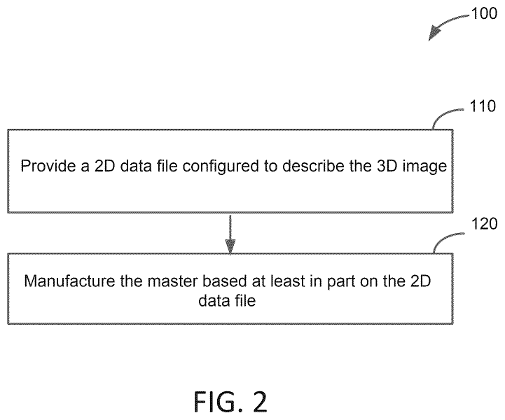

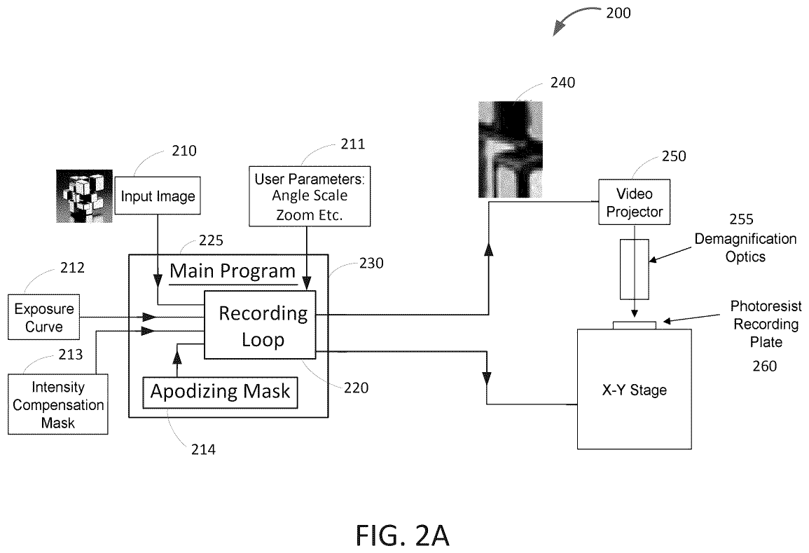

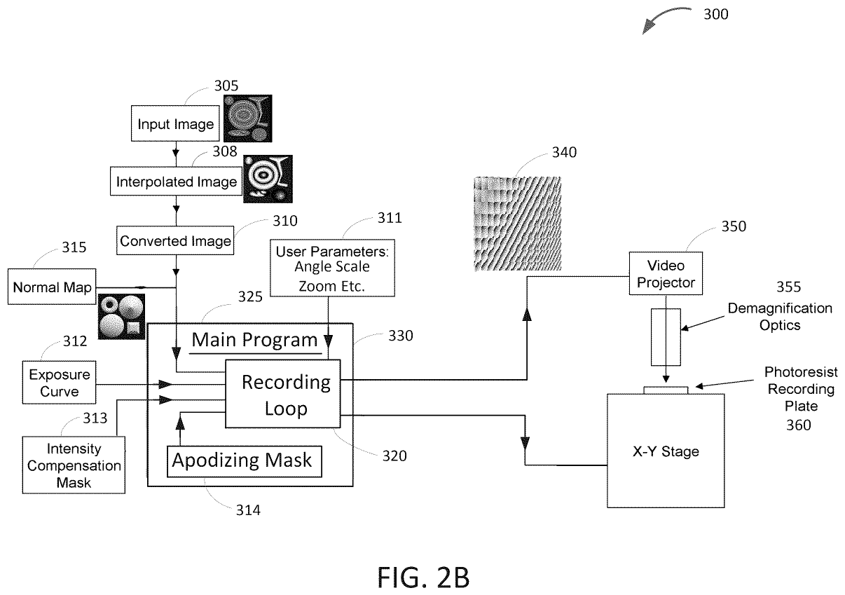

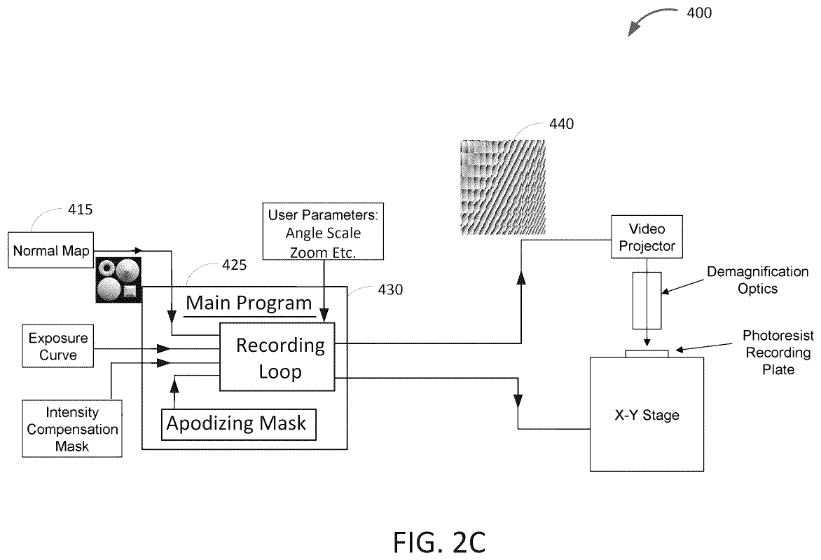

Various methods can be used to manufacture the master 10 for fabricating an optical product 10′. An example method 100 is shown in FIG. 2. As shown in operational block 110, the method 100 can include providing a data file, e.g., a 2D data file, configured to describe, characterize, and/or record features the 3D object and/or 3D image 50′. The data file can provide the pattern of the features F₁, F₂, . . . Fₙ on the surface 12 of the master 10.

For example, the data file can comprise a plurality of portions (as will be described further herein). Each portion can correspond to one or more points on a surface S of the 3D object 50. Each portion can comprise features of intensity corresponding to non-holographic elements on the optical product 10′. A gradient in intensity can correlate to an inclination of the surface S of the 3D object 50 at the one or more corresponding points. In addition, an orientation of the features can correlate to an orientation of the surface S of the 3D object 50 at the one or more corresponding points. As shown in operational block 120, the method 100 can further include manufacturing the master 10 based at least in part on the 2D data file.

As described herein, certain embodiments of the optical product 10′ can produce a bright, mirror-like image. In some implementations, a matte finish may be desired. FIG. 2A illustrates an example method that can be used to manufacture a surface relief diffuser and also to determine a height displacement file used to manufacture the diffuser. In the method 200 shown in FIG. 2A, an input image 210 of the 3D object 50 (e.g., a 2D photograph of the 3D object) is entered into the recording loop 220 of the main program 225 of the processor 230. Other information, such as user parameters 211 (e.g., angle, scale, zoom, etc.), exposure compensation curve 212, intensity compensation mask 213, and apodizing mask 214 can also be entered into the recording loop 220. The processor 230 can produce a height displacement file 240 that is configured to describe the intensities of the 3D object 50. This height displacement file 240 can be used as a map to generate the pattern of the diffuser. In some examples of the height displacement file 240, the intensities of the 3D object can be correlated to a depth for the diffuser. For example, the black sections of the 3D object 50 can correlate to the surface of the diffuser, white sections of the 3D object 50 can correlate to a lower depth (e.g., down 10 μm), and grey sections of the 3D object 50 can correlate to some depth in between. Other variations are possible.

In the example method 200 shown in FIG. 2A, a digital micromirror device (DMD) video projector 250 can be used along with the photoresist recording plate 260, each receiving the inputted information from the recording loop 220. The DMD video projector 250 includes a DMD chip that includes a plurality of micromirrors that in certain embodiments can correspond to the pixels of the height displacement file 240. The pixels of the height displacement file 240 can also correspond to the regions on the X-Y stage of the photoresist recording plate 260 in some embodiments. Each micromirror of the DMD chip can be used as a spatial light modulator that, for example, reflects light from a light source in the video projector 250 in the on-state, and that does not reflect light in the off-state. Varying the amount of light intensity can be produced by varying the time the micromirror is in the on- and off-states (e.g., pulse width modulation, etc.). As shown in FIG. 2A, demagnification optics 255 can be used to produce the pattern of the diffuser in a light sensitive material, e.g., a photoresist, on the resist recording plate 260. In some embodiments, the resist can be used as the diffuser. As disclosed herein, other techniques, such as electron beam lithography on electron sensitive material and ion beam lithography on ion sensitive material can also be used. Certain embodiments of the diffuser can be used with certain embodiments of the optical product 10′ to produce a diffuse or hazy layer over the reflected image 50′ to produce an image with a matte finish.

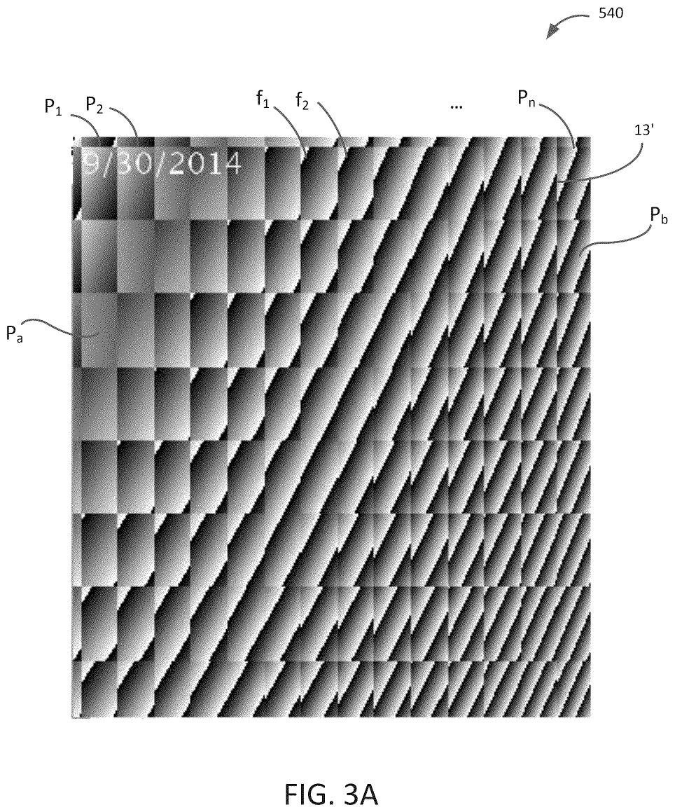

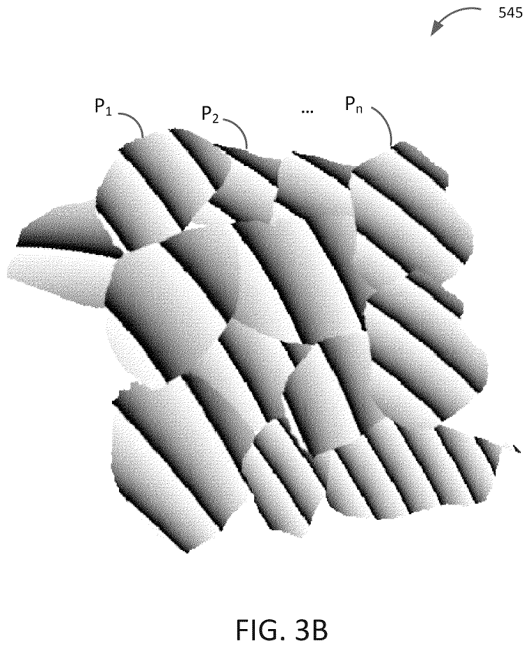

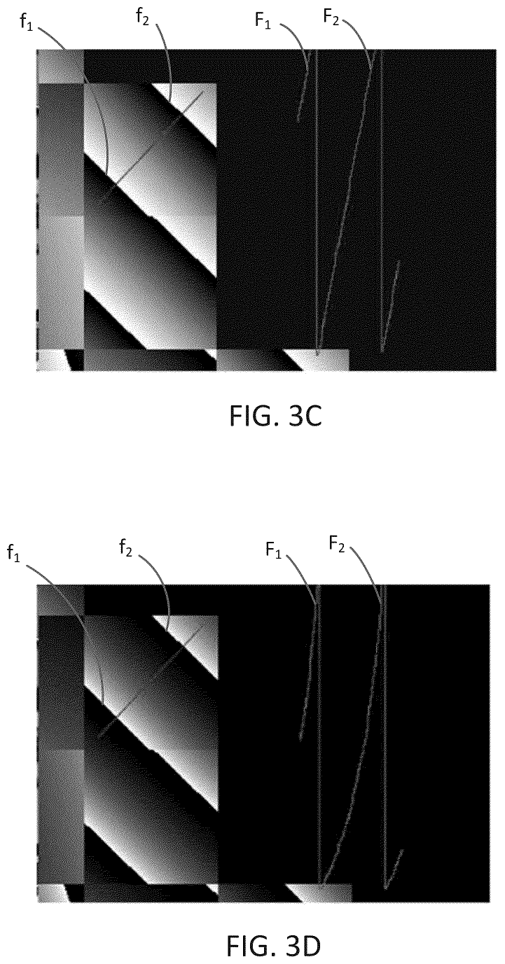

FIG. 2B illustrates an example method that can be used to manufacture the master 10 and also to determine the data file to be used to manufacture the master 10, e.g., to determine the pattern of the features F₁, F₂, . . . Fₙ on the surface 12 of the master 10. Certain such embodiments can be advantageous as a 3D physical object and/or a 3D model utilizing physical dimensions of the 3D object (e.g., topographical calculations) are not required. For example, in the method 300 shown in FIG. 2B, the input image 305 can be a 2D input image (e.g., a 2D photograph of the 3D object) or 2D image converted from a 3D image. In some embodiments, the input image 305 can be converted into a 2D interpolated image 308 and produced as a 2D converted image 310. The 2D image of the 3D object can be translated into a gray scale image (e.g., a normal map 315 wherein black, white, and gray regions correlate to different heights of the 3D object). In the method 300 shown in FIG. 2B, the converted image 310 (or a normal map 315) is entered into the recording loop 320 of the main program 325 of the processor 330 in accordance with certain embodiments described herein. Similar to the method 200 in FIG. 2A, other information, such as user parameters 311 (e.g., angle, scale, zoom, etc.), exposure compensation curve 312, intensity compensation mask 313, and apodizing mask 314 can also be entered into the recording loop 320. The processor 330 can produce a data file 340, e.g., a 2D data file, that is configured to describe the 3D image 50′ of at least a part of the 3D object 50. In some embodiments, the intensities in the data file 340 can be assigned based on gray scale. For example, the data file 340 can comprise a plurality of portions. Each portion can correspond to one or more points on a surface S of the 3D object 50. Each portion can comprise features of intensity corresponding to non-holographic elements on the optical product 10′. A gradient in intensity can correlate to a gradient or an inclination of the surface S of the 3D object 50 at the one or more corresponding points. In addition, an orientation of the features can correlate to an orientation of the surface S of the 3D object 50 at the one or more corresponding points. This data file 340 can be used as a map to generate the pattern of features F₁, F₂, . . . Fₙ on the surface 12 of the master 10. An example data file is discussed with respect to FIG. 3A.

Similar to method 200 in FIG. 2A, a digital micromirror device (DMD) video projector 350 can be used along with the photoresist recording plate 360, each receiving the inputted information from the recording loop 320. The plurality of micromirrors in the DMD video projector 350 in certain embodiments can correspond to the pixels of the data file 240. The pixels of the data file 340 can also correspond to one or more portions P₁, P₂, . . . Pₙ of the surface 12 of the master 10 in some embodiments. As shown in FIG. 2B, the demagnification optics 355 can be used to produce the pattern of features F₁, F₂, . . . Fₙ in a light sensitive material, e.g., a photoresist, on the resist recording plate 360. In some embodiments, the resist can be used as the surface 12 of the master 10. As disclosed herein, other techniques, such as electron beam lithography on electron sensitive material and ion beam lithography on ion sensitive material can also be used.

In some embodiments, the method 300 can further include adding on the master 10 features corresponding to holographic elements on the optical product 10′. For example, an optical recording (e.g., a planar optical recording) for the holographic elements can be superimposed onto the master 10 to add the holographic elements on the master 10. As another example, in some embodiments, the data file 340 can include features corresponding to holographic elements on the optical product 10′. In other embodiments, a separate data file comprising the features of intensity corresponding to holographic elements on the optical product 10′ can be provided. Manufacturing the master 10 can be based at least in part on the data file 340 including features corresponding to non-holographic elements and on the data file including features corresponding to holographic elements on. In some such embodiments, the data file 340 including the features corresponding to non-holographic elements and the data file including the features corresponding to holographic elements can be used sequentially or simultaneously to manufacture the master 10. In some other embodiments, a needle, such as from an atomic force microscope, can be used to produce the features corresponding to the holographic elements on the optical product 10′. Other methods can be employed to add holographic features or elements.

FIG. 2C illustrates yet another example method that can be used to determine the pattern of the features F₁, F₂, . . . Fₙ on the surface 12 of the master 10. The method 400 shown in FIG. 2C is similar to the method 300 shown in FIG. 2B except that a normal map 415 can be provided instead of the input image 310. The normal map 415 can be inputted into the main program 425 of the processor 430 to produce the data file 440.

FIG. 3A illustrates an example 2D data file 540 in accordance with certain embodiments disclosed herein. The data file 540 can include a plurality of portions p₁, p₂, . . . pₙ. In some embodiments, the plurality of portions p₁, p₂, . . . pₙ can form a single cell (e.g., a mono-cell). In other embodiments, as shown in FIG. 3A, the plurality of portions p₁, p₂, . . . pₙ can form a plurality of cells. In various embodiments, the portions p₁, p₂, . . . pₙ can form a pixelated surface corresponding to the portions P₁, P₂, . . . Pₙ of the surface 12 of the master 10. For example, as shown in FIG. 3A, the portions p₁, p₂, . . . pₙ can include a plurality of rows and columns.

As also shown in FIG. 3A, in some embodiments, borders 13′ can surround at least part of the portions p₁, p₂, . . . pₙ. The borders 13′ can substantially surround a portion pₙ or can surround just part of a portion pₙ. As with the master 10, the size and shape of the portions p₁, p₂, . . . pₙ on the data file 540 are not particularly limited. Some of the portions p₁, p₂, . . . pₙ can comprise a symmetrical shape. For example, the symmetrical shape can include a rectangle, a square, a rhombus, an equilateral triangle, an isosceles triangle, a regular polygon (e.g., a regular pentagon, a regular hexagon, a regular octagon), etc. The shape can also include curvature, e.g., a circle, an ellipse, etc. In other embodiments, some of the portions p₁, p₂, . . . pₙ can comprise a non-symmetrical shape, e.g., a non-rotationally symmetrical shape, and/or an irregular shape. For example, FIG. 3B illustrates an example embodiment of a data file 545 with irregularly shaped portions p₁, p₂, . . . pₙ. In some embodiments, some of the portions p₁, p₂, . . . pₙ can have a shape that is substantially the same as other portions p₁, p₂, . . . pₙ. In other embodiments, e.g., as shown in FIG. 3B, some of the portions p₁, p₂, . . . pₙ can have a shape that is different from other portions p₁, p₂, . . . pₙ.

As with the master 10, the arrangement of the portions p₁, p₂, . . . pₙ in the data file 540 is not particularly limited. For example, whether with or without borders, whether symmetrically shaped or non-symmetrically shaped, or whether regularly or irregularly shaped, the portions p₁, p₂, . . . pₙ can form a periodic array. For example, in FIG. 3A, the portions p₁, p₂, . . . pₙ form a periodic array. In other embodiments, whether with or without borders, whether symmetrically shaped or non-symmetrically shaped, or whether regularly or irregularly shaped, the portions p₁, p₂, . . . pₙ can form an aperiodic array. For example, in FIG. 3B, the portions p₁, p₂, . . . pₙ form an aperiodic array. In yet other embodiments, the portions p₁, p₂, . . . pₙ can form a combination of periodic and aperiodic arrays.

With continued reference to FIG. 3A, each portion pₙ can include features f₁, f₂, . . . fₙ that correspond to features F₁, F₂, . . . Fₙ on the surface 12 of the master 10. Portion pₐ has a single feature f₁, while portion p_{b} has multiple features fₙ. The features f₁, f₂, . . . fₙ of the data file 540 can include features of intensity (varying dark and light lines). In some embodiments, the intensity can correlate to the height of a feature on the surface S of the 3D object 50.

In various embodiments, a lateral distance between two features can be defined in some embodiments as a pitch. In some embodiments, the pitch between features within a portion pₙ can be substantially the same within the portion pₙ. For example, in various embodiments, in portion p₁ of the portions p₁, p₂, . . . pₙ, the feature f₁ can comprise a plurality of features that form a periodic array such that the pitch is substantially the same within portion p₁. In addition, in some embodiments, the features f₁, f₂, . . . fₙ among multiple portions p₁, p₂, . . . pₙ, can form a periodic array such that the pitch is substantially the same among multiple portions p₁, p₂, . . . pₙ.

In other embodiments, the features can form an aperiodic array such that the pitch may be different among multiple portions p₁, p₂, . . . pₙ. However, although the pitch may be different for different portions p₁, p₂, . . . pₙ, in some embodiments, the pitch can be slowly varying (e.g., less than 15% change per lateral distance, less than 12% change per lateral distance, less than 10% change per lateral distance, less than 8% change per lateral distance, less than 5% change per lateral distance, less than 3% change per lateral distance, or less than 1% change per lateral distance) among the portions p₁, p₂, . . . pₙ. In some embodiments, the pitch may uniformly change across multiple portions p₁, p₂, . . . pₙ.

In other embodiments, the features could be chirped within a portion pₙ such that the pitch may be different within the portion pₙ. In some such embodiments, the pitch within the portion pₙ may slowly vary (e.g., less than 15% change per lateral distance, less than 12% change per lateral distance, less than 10% change per lateral distance, less than 8% change per lateral distance, less than 5% change per lateral distance, less than 3% change per lateral distance, or less than 1% change per lateral distance).

FIG. 3A shows an example data file 540 with linear features where the pitch is substantially uniform within a portion pₙ, and FIG. 3B shows an example data file 545 with curved features where the pitch is substantially uniform within a portion pₙ. FIG. 3A is also an example of features having a pitch that slowly changes (e.g., less than 10% change per lateral distance) across multiple portions p₁, p₂, . . . Pₙ.

In various embodiments, each feature of intensity can include a slope. Various embodiments can advantageously have a uniform gradient (e.g., uniform slope) within each portion pₙ such that the gradient is a single value (e.g., a single polar angle θₙ) at the corresponding point Sₙ on the surface S of the 3D object 50. The gradient in the features f₁, f₂, . . . fₙ can correlate to an inclination of the surface S of the 3D object 50 at the corresponding point S₁, S₂, . . . Sₙ. In other embodiments, the feature fₙ within a portion pₙ includes a plurality of features, and the features within the portion pₙ may have more than one gradient (e.g., different slopes). In such embodiments, the average gradient (e.g., average slope) of the features within the portion pₙ can correlate to the inclination of the surface S of the 3D object 50 at the corresponding point Sₙ.

Various embodiments can also advantageously have a uniform orientation within each portion pₙ, such that the orientation is a single value (e.g., a single azimuth angle φₙ) at the corresponding point Sₙ on the surface S of the 3D object 50. In various embodiments, the orientation of features f₁, f₂, . . . fₙ can correlate to an orientation of the surface S of the 3D object 50 at the corresponding point S₁, S₂, . . . Sₙ. In other embodiments, the feature fₙ within a portion pₙ includes a plurality of features, and the features within the portion pₙ may have more than one orientation (e.g., different orientations). In such embodiments, the average orientation of the features within the portion pₙ can correlate to the orientation of the surface S of the 3D object 50 at the corresponding point Sₙ. Furthermore, the orientation of the features within and among the portions p₁, p₂, . . . pₙ, can slowly vary (e.g., less than 15% change per lateral distance, less than 12% change per lateral distance, less than 10% change per lateral distance, less than 8% change per lateral distance, less than 5% change per lateral distance, less than 3% change per lateral distance, or less than 1% change per lateral distance) within and among the portions p₁, p₂, . . . Pₙ.

In some embodiments, where a feature f₁ includes multiple features within a portion, the features can appear discontinuous with other features within the portion. In some embodiments where the surface 12 of the master 10 is pixelated (e.g., having a plurality of cells), the features f₁, f₂, . . . fₙ can appear discontinuous with features in surrounding adjacent portions. Based on pixel or cell size and/or tolerances in creating the data file 540, some embodiments may include random discontinuities with substantially no (relatively little if any) negative impact in image reproduction. Such discontinuity can reduce iridescence. In other embodiments, the portions p₁, p₂, . . . pₙ can form a single cell or a mono-cell. In some such embodiments, the features f₁, f₂, . . . fₙ can appear continuous and smoothly varying depending on the shape. In other such embodiments, the features f₁, f₂, . . . fₙ can appear discontinuous due to discontinuities in the 3D object 50.

In some embodiments, as shown in FIG. 3C, the features f₁, f₂, . . . fₙ can comprise linear features corresponding to a substantially smooth region of the surface S of the 3D object 50. The features f₁, f₂, . . . fₙ can be used to produce linear features F₁, F₂, . . . Fₙ on the surface 12 of the master 10. The features f₁, f₂, . . . f can also be used to produce non-linear features F₁, F₂, . . . Fₙ on the surface 12 of the master 10. In some embodiments, features f₁, f₂, . . . fₙ that are linear can be used to correspond to a curved region of the surface S of the 3D object 50. In some such embodiments, linear features f₁, f₂, . . . fₙ in the data file can be used to represent a curved region by using a piecewise approximation function.

As shown in FIG. 3D, in some embodiments, although linear features f₁, f₂, . . . fₙ in the data file can correspond to a substantially smooth region of the surface S of the 3D object 50, non-linear features on the master 10 (e.g., curved facets shown in left profile) can be used. As described herein, in some such embodiments, non-linear features on the master 10 can be used to produce elements E₁, E₂, . . . Eₙ on an optical product 10′ that can appear smooth because the corresponding features on the optical product 10′ can be relatively small (e.g., between 1 μm and 100 μm, between 1 μm and 75 μm, between 1 μm and 50 μm, or between 1 μm and 25 μm).

As the features f₁, f₂, . . . fₙ of the data file 540 correspond to aspects of the surface S of the 3D object 50, the features f₁, f₂, . . . fₙ of the data file 540 can be used to produce the features F₁, F₂, . . . Fₙ on the surface 12 of the master 10. As described herein, the features F₁, F₂, . . . Fₙ on the surface 12 of the master 10 can be used to fabricate the elements E₁, E₂, . . . Eₙ on the surface 12′ of the optical product 10′. As described herein, in various embodiments, the elements E₁, E₂, . . . Eₙ on the optical product 10′ can be non-holographic. For example, the elements E₁, E₂, . . . Eₙ do not need to rely on holography to render a 3D image 50′ of the 3D object 50.

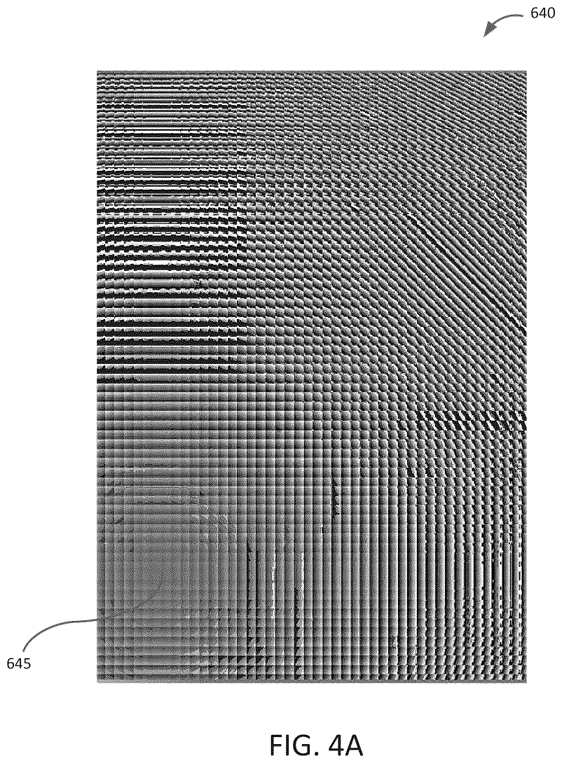

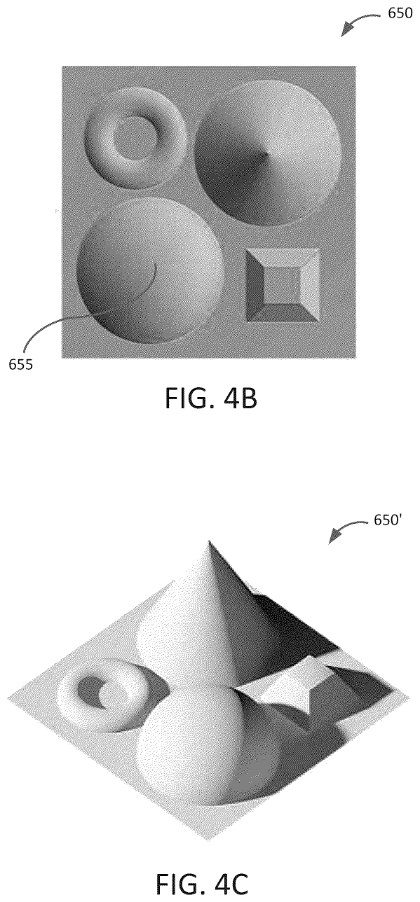

FIG. 4A is another example 2D data file 640 prepared in accordance with certain embodiments described herein. The data file 640 was generated by the normal map 650 shown in FIG. 4B. As an example, the lower left portion 645 of the data file 640 represents the center of the hemispherical object 655 in the lower left portion of the normal map 650. The data file 640 was used to generate the features F₁, F₂, . . . Fₙ on the surface 12 of a master 10, which was used to fabricate the elements E₁, E₂, . . . Eₙ on the surface 12′ of an optical product 10′. The optical product 10′ was configured, when illuminated, to reproduce by reflected light, the 3D image 650′ shown in FIG. 4C.

In certain embodiments, an optical product 10′ is also disclosed herein. As described herein, the optical product 10′ can be configured, when illuminated, to reproduce by reflected light, a 3D image 50′ of at least a part of a 3D object 50. As shown in FIG. 1A, similar to the master 10, the optical product 10′ can include a surface 12′ comprising a plurality of portions P′₁, P′₂, . . . P′ₙ. Each portion P′ₙ can correspond to a point Sₙ on a surface S of the 3D object 50. Each portion P′ₙ can comprise features, e.g., non-holographic elements E₁, E₂, . . . Eₙ. In certain embodiments, the non-holographic elements E₁, E₂, . . . Eₙ can be configured to produce at least part of the 3D image 50′ without relying on diffraction. In various embodiments, the portions P′₁, P′₂, . . . P′ₙ can form a single cell (e.g., a mono-cell). In other embodiments, the portions P′₁, P′₂, . . . P′ₙ can form a plurality of cells. Each portion P′ₙ can form a cell of the plurality of cells. The optical product 10′ can include borders surrounding at least part of the portions P′₁, P′₂, . . . P′ₙ.

A gradient (e.g., uniform slope or average slope) in the non-holographic features E₁, E₂, . . . Eₙ can correlate to an inclination of the surface S of the 3D object 50 at the corresponding point S₁, S₂, . . . Sₙ. In addition, the orientation (e.g., uniform orientation or average orientation) of the non-holographic features E₁, E₂, . . . Eₙ can correlate to an orientation of the surface S of the 3D object 50 at the corresponding point S₁, S₂, . . . Sₙ.

Furthermore, since the master 10 can be used to fabricate an optical product 10′, aspects disclosed herein with reference to the master 10 can apply to certain embodiments of the optical product 10′. For example, disclosure with respect to the shapes (e.g., symmetrical, non-symmetrical, irregular, curved, etc.) and arrangements (e.g., periodic, aperiodic, etc.) of the portions P₁, P₂, . . . Pₙ for the master 10 can apply to the shapes and arrangements of the portions P′₁, P′₂, . . . P′ₙ of the optical product 10′. As another example, disclosure with respect to the features F₁, F₂, . . . Fₙ (e.g., linear, curved, periodic, aperiodic, slowly varying, continuous, discontinuous, non-sinusoidal, etc.) for the master 10 can apply to the features E₁, E₂, . . . Eₙ of the optical product 10′. Furthermore, as described herein with respect to the master and the method of manufacturing the master, the optical product 10′ of certain embodiments can further comprise features corresponding to holographic features.

In addition, small features can be imbedded in the optical product 10′ that do not contribute to the formation of the image. Such imbedded features can be used in authenticity and security applications. Furthermore, as described herein, certain embodiments can incorporate intentional variations within one or more portions P′₁, P′₂, . . . P′ₙ of the optical product 10′ for security applications.

The terms “about” and “substantially” as used herein represent an amount equal to or close to the stated amount (e.g., an amount that still performs a desired function or achieves a desired result). For example, unless otherwise stated, the terms “about” and “substantially” may refer to an amount that is within (e.g., above or below) 10% of, within (e.g., above or below) 5% of, within (e.g., above or below) 1% of, within (e.g., above or below) 0.1% of, or within (e.g., above or below) 0.01% of the stated amount.

Various embodiments of the present invention have been described herein. Although this invention has been described with reference to these specific embodiments, the descriptions are intended to be illustrative of the invention and are not intended to be limiting. Various modifications and applications may occur to those skilled in the art without departing from the true spirit and scope of the invention.

1.-115. (canceled)

116. An optical product configured, when illuminated, to reproduce by reflected light, a 3D image of at least a part of a 3D object, said optical product comprising:
a first surface; and
a second surface opposite said first surface, said second surface comprising a plurality of portions, each portion corresponding to a point on a surface of said 3D object, each portion comprising non-holographic features configured to produce at least part of said 3D image of said 3D object without relying on diffraction,
wherein a gradient in said non-holographic features correlates to an inclination of said surface of said 3D object at said corresponding point, and
wherein an orientation of said non-holographic features correlates to an orientation of said surface of said 3D object at said corresponding point.

117. The optical product of claim 116, wherein a majority of said plurality of portions comprises one or more non-holographic features having different orientations as one or more non-holographic features in surrounding adjacent portions.

118. The optical product of claim 116, wherein said second surface further comprises additional features that when illuminated, do not reproduce a part of said 3D object.

119. The optical product of claim 116, wherein said inclination comprises a polar angle from a first reference line of said 3D object, and said orientation comprises an azimuth angle from a second reference line orthogonal to said first reference line.

120. The optical product of claim 116, wherein said optical product is configured to provide authenticity verification on an item for security.

121. The optical product of claim 120, wherein said item for security comprises currency, a credit card, a debit card, a passport, a driver's license, an identification card, a document, a tamper evident container or packaging, or a bottle of pharmaceuticals.

122. The optical product of claim 116, wherein said optical product is an embedded feature, a laminated feature, a hot stamp feature, windowed thread feature, or a transparent window feature.

123. The optical product of claim 116, wherein said 3D object comprises an irregularly shaped object.

124. The optical product of claim 116, wherein said 3D object comprises a non-symmetrical shaped object.

125. The optical product of claim 124, wherein said 3D object comprises one or more animals, humans, plants, trees, landscapes, buildings, cars, boats, airplanes, bicycles, furniture, office equipment, drinks, personal care items, or flags.

126. The optical product of claim 116, wherein said one or more non-holographic features comprise one or more mirrors configured to produce a mirror-like image by reflecting light.

127. The optical product of claim 116, wherein said 3D object comprises an object in nature.

128. The optical product of claim 116, wherein said 3D object comprises a man-made object.
